(19) United States
(12) Patent Application Publication
(10) Pub. No.: US 2026/0366611 A1
(43) Pub. Date: Nov. 19, 2026

(54) FLUID FLOW DIVERTER AND AXLE ASSEMBLY

(71) Applicant: Traction Drive Holdco LLC, Columbus, IN (US)

(72) Inventor: Brian David Hayes, Newark, OH (US)

(73) Assignee: Traction Drive Holdco LLC, Columbus, IN (US)

(21) Appl. No.: 19/671,864

(22) Filed: May 8, 2026

Related U.S. Application Data
(60) Provisional application No. 63/806,384, filed on May 15, 2025.

(51) Int. Cl. F16H 57/04; B60K 17/22

(52) U.S. Cl. CPC F16H 57/0423; B60K 17/22

(57) ABSTRACT

A fluid flow diverter and an axle assembly that includes a fluid flow diverter. The fluid flow diverter comprises a ring and a vane. The ring encircles an axis. The vane comprises a first vane end and a second vane end. The first vane end is below the axis. The second vane end is above the axis.

### CROSS-REFERENCE TO RELATED APPLICATIONS

This application claims the benefit of U.S. provisional application no. 63/806,384, filed May 15, 2025, the disclosure of which is incorporated in its entirety by reference herein.

### TECHNICAL FIELD

The invention relates to a fluid flow diverter and an axle assembly that includes a fluid flow diverter.

### BACKGROUND

An example of an axle assembly that has a rotatable drive pinion and an interaxle differential unit is disclosed in U.S. Patent No. 9,816,603. An example of an axle assembly that has a rotatable drive pinion and an electric motor is disclosed U.S. Patent No. 11,859,718.

### SUMMARY

The invention relates to a fluid flow diverter. The fluid flow diverter comprises a ring and a vane. The ring encircles an axis. The vane protrudes away from the ring and toward the axis. The vane comprises a first vane end and a second vane end opposite the first vane end. The first vane end is disposed below the axis. The second vane end is disposed above the axis.

The first vane end may be disposed closer to the axis than the second vane end. The first vane end may be radially disposed closer to the axis than the second vane end is disposed to the axis. At least a portion of the vane may extend along an arc between the first vane end and the second vane end.

The fluid flow diverter may comprise an insert. The insert may be encircled by the ring. The insert and the ring may be separate parts. The vane may be provided with the insert. The insert may extend from the ring. The insert may be fixedly positioned with respect to the ring.

The fluid flow diverter may comprise a second vane. The second vane may protrude away from the ring and toward the axis. The vane and the second vane may be disposed at opposite ends of the insert.

The vane may comprise a first segment and a second segment. The first segment may extend from the first vane end. The first segment may extend toward the second end of the ring. The first segment may be disposed below the axis. The second segment may extend from the first segment to the second vane end.

The second segment may be disposed farther from the axis as a distance from the first segment increases. For example, the second segment may have an inner side that faces toward the axis. The inner side may be disposed farther from the axis as a distance from the first segment increases.

The ring may comprise a first end and a second end. The first end may encircle a first opening. The second end may be disposed opposite the first end. The second end may encircle a second opening. The first opening may have a smaller diameter than the second opening. The first segment of the vane may be disposed in the first opening.

The vane and the ring may cooperate to define a channel. The channel may extend in an axial direction from the first end to the second end of the ring.

The ring may comprise the vane. The ring may comprise an interior side. The inner side may face toward the axis. The vane may extend from the interior side toward the axis. The vane may extend from the first end to the second end. The vane may be disposed closer to the axis at the first end than at the second end.

The invention also relates to an axle assembly. The axle assembly comprises a shaft and a fluid flow diverter. The shaft extends along an axis. The fluid flow diverter is spaced apart from the shaft. The fluid flow diverter comprises a ring and a vane. The ring encircles the shaft. The vane protrudes away from the ring and toward the axis. The vane comprises a first vane end and a second vane end opposite the first vane end. The first vane end is below the axis. The second vane end is above the axis.

The shaft may be a drive pinion that is rotatable about the axis.

### BRIEF DESCRIPTION OF THE DRAWINGS

FIG. 1 is a section view of an example of an axle assembly that comprises a fluid flow diverter.

FIG. 2 is a magnified view of a portion of FIG. 1.

FIG. 3 is a perspective view of a first example of a fluid flow diverter.

FIG. 4 is a side view of the fluid flow diverter of FIG. 3.

FIG. 5 is a section view of the fluid flow diverter of FIG. 3 along section line 5-5.

FIG. 6 is a section view of the fluid flow diverter of FIG. 3 along section line 6-6.

FIGS. 7 and 8 are exploded views of the fluid flow diverter of FIG. 3.

FIG. 9 is a side view of an insert of the fluid flow diverter shown in FIG. 3.

FIGS. 10 and 11 are perspective views of a second example of a fluid flow diverter.

FIG. 12 is a side view of the fluid flow diverter of FIGS. 10 and 11.

FIG. 13 is a section view of the fluid flow diverter of FIGS. 10 and 11 along section line 13-13.

FIG. 14 is a section view of the fluid flow diverter of FIGS. 10 and 11 along section line 14-14.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, steps, operations, elements, and/or components, but do not preclude the presence or addition of one or more other features, steps, operations, elements, components, and/or groups thereof.

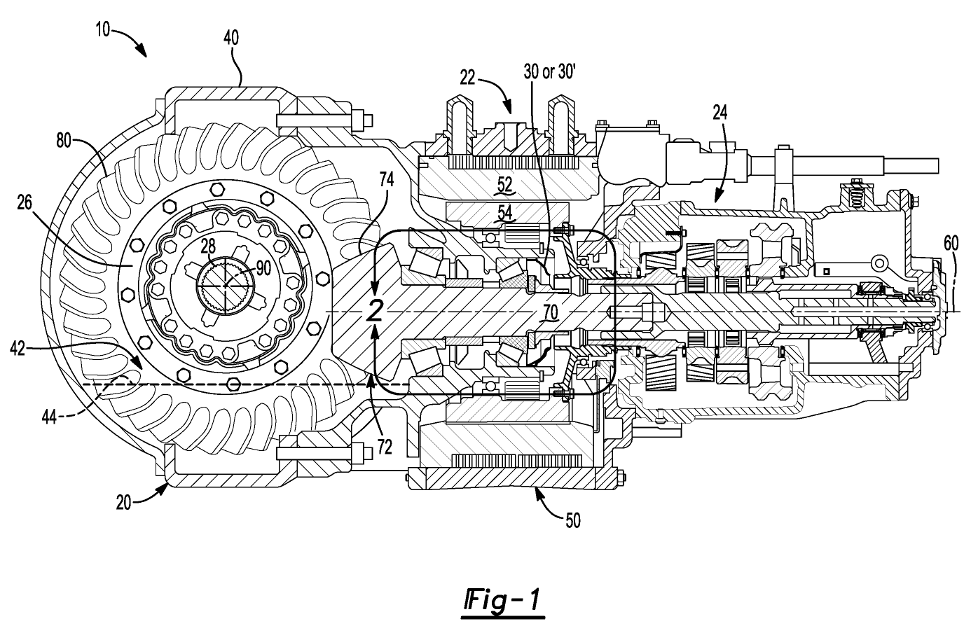

Referring to FIG. 1, an example of an axle assembly 10 is shown. The axle assembly 10 may be provided with a land vehicle, such as a truck, farm equipment, military transport or weaponry vehicle, or cargo loading equipment for land, air, or marine vessels. In some configurations, the vehicle may include a trailer for transporting cargo.

As an overview, an axle assembly may be provided with a fluid flow diverter that encircles a rotatable shaft. During operation, the shaft rotates about an axis. Rotation of the shaft may cause a fluid, such as a lubricant like oil, to be flung away from the shaft and rotate around the axis, such as in the same direction as the rotating shaft. As a result, fluid flow along the shaft or in an axial direction may be slowed or hindered. The addition of a fluid flow diverter in accordance with the present invention may increase the fluid flow rate along the shaft or in an axial direction, which in turn may improve fluid circulation in the axle assembly. For instance, the fluid flow diverter may help increase the flow rate of lubricant through the fluid flow diverter. In some configurations, the flow rate may increase as the rotation speed of the shaft increases, which may help increase the amount of lubricant that passes through the fluid flow diverter and that can be provided to rotating components, such as gears and bearings of the axle assembly. This lubricant may facilitate lubrication of the rotating components, heat transfer from the rotating components, or both.

Examples of fluid flow diverters are described below primarily in the context of the example of an axle assembly shown in FIG. 1, in which the fluid flow diverter directs fluid between an axle housing and a transmission. However, it is to be understood that the fluid flow diverter may be provided with other axle assembly configurations. For example, the fluid flow diverter can facilitate the flow of lubricant to or from an interaxle differential unit of an axle assembly. An example of an axle assembly that has an interaxle differential unit and a rotatable drive pinion is disclosed in U.S. Patent No. 9,816,603, the disclosure of which is incorporated by reference in its entirety. It is also to be understood that the axle assembly may or may not incorporate an electric motor that provides torque to the shaft.

Referring to FIG. 1, the example of an axle assembly 10 is configured as a drive axle assembly. A drive axle assembly is configured to provide torque to one or more wheel assemblies. A wheel assembly may include a tire disposed on a wheel. In some configurations, a wheel assembly may be rotatably supported on the axle assembly 10. For example, the wheel may be mounted to a wheel hub that is rotatable about an axis and the wheel hub is rotatably disposed on an axle housing of the axle assembly 10.

In some configurations, an axle assembly 10 includes a housing assembly 20, an electric motor 22, a transmission 24, a differential assembly 26, and a pair of axle shafts 28. The positioning of the electric motor 22, the transmission 24, or the differential assembly 26, may differ from that shown. For instance, in some configurations the differential assembly 26 may be positioned between the electric motor 22 and the transmission 24. It is also contemplated that the electric motor 22 may be omitted or may be remotely positioned from the axle assembly 10 and may not be part of the axle assembly 10 in some configurations. The axle assembly 10 also includes a fluid flow diverter 30 or 30’.

The housing assembly 20 receives various components of the axle assembly 10. In addition, the housing assembly 20 may facilitate mounting of the axle assembly 10 to the vehicle. In some configurations, the housing assembly 20 comprises an axle housing 40.

The axle housing 40 receives various components of the axle assembly 10. In some configurations, the axle housing 40 at least partially receives the differential assembly 26. In some configurations, the axle housing 40 also at least partially receives the axle shafts 28. A lower region of the axle housing 40 may at least partially define a sump portion 42. The sump portion 42 may contain a fluid 44, such as lubricant or lubricating fluid like oil, which may be splashed or sprayed by the differential assembly 26 when the differential assembly 26 rotates. This fluid may be routed or directed to lubricate components of the axle assembly 10, such as the transmission 24, the differential assembly 26, and associated bearings.

The electric motor 22, if provided, is configured to provide torque, such as propulsion torque or regenerative braking torque. Propulsion torque may be used to propel the vehicle, such as in a forward or backward direction. Propulsion torque may also be used to hold the vehicle in a stationary position or to help reduce, limit, or prevent vehicle rollback, such as when the vehicle is on an inclined surface. Regenerative braking may provide a regenerative braking torque. Regenerative braking may capture kinetic energy when the electric motor 22 is used to brake or slow the vehicle. Recovered energy may be transmitted from the wheel assemblies to drive the electric motor 22. Thus, the electric motor 22 may function as a generator and may be used to charge an electric power source, such as a battery. The electric motor 22 may be electrically connected to the electric power source via an inverter in a manner known by those skilled in the art.

The electric motor 22 may be of any suitable type. For instance, the electric motor 22 may be a three phase alternating current (AC) electric motor. In some configurations, the electric motor 22 comprises an electric motor housing 50, a stator 52, and a rotor 54.

The electric motor housing 50 receives the stator 52 and the rotor 54. In some configurations, the electric motor housing 50 is mounted to the housing assembly 20.

The stator 52 is fixedly positioned with respect to the electric motor housing 50. In some configurations, the stator 52 encircles the rotor 54.

The rotor 54 is rotatable about an axis with respect to the stator 52. In the configuration shown, the rotor 54 is rotatable about axis 60; however, it is contemplated that the rotor 54 may be rotatable about a different axis, such as an axis of rotation of the differential assembly 26 or an axis that differs from an axis of rotation of a shaft that is encircled by the fluid flow diverter 30, 30’. The rotor 54 is operatively connected to the transmission 24.

The transmission 24 operatively connects the electric motor 22 and the differential assembly 26. For example, the transmission 24 facilitates the transmission of torque between the electric motor 22 and the differential assembly 26. Torque transmission may be bidirectional. For instance, torque may be transmitted from the electric motor 22 to the differential assembly 26 via the transmission 24 (and from the differential assembly 26 to a wheel hub and wheel assembly via a corresponding axle shaft 28) to propel the vehicle. Torque may be transmitted from a wheel assembly to the differential assembly 26 via a corresponding axle shaft 28 and from the differential assembly 26 to the electric motor 22 via the transmission 24 to operate the electric motor 22 as a generator. In some configurations, the transmission 24 may provide gear reduction and multiple gear ratios between the rotor 54 and the differential assembly 26.

The transmission 24 may be of any suitable type. For instance, the transmission 24 may be a countershaft transmission, an epicyclic transmission (e.g., a transmission having a planetary gear set), or the like. A countershaft transmission may include a single countershaft or multiple countershafts. Examples of an axle assembly having a single countershaft transmission are disclosed in U.S. Patent Nos. 11,002,352 and 11,209,072. Examples of an axle assembly having a dual countershaft transmission is disclosed in in U.S. Patent Nos. 10,989,288, 11,207,976, and 11,220,176. Examples of an axle assembly having an epicyclic transmission are disclosed in U.S. Patent Nos. 11,038,396 and 11,428,297. The transmission may comprise an interaxle differential unit such as is disclosed in U.S. Patent No. 9,816,603. The disclosures of the references in the preceding four sentences are hereby incorporated in their entirety by reference herein.

In some configurations, the transmission 24 includes a shaft 70. The shaft 70 is rotatable about an axis, such as axis 60. The shaft 70 may extend along the axis 60. In some configurations, the shaft 70 is a drive pinion 72 or is part of a drive pinion 72 that operatively connects the transmission 24 to the differential assembly 26. For instance, a shaft 70 that is a drive pinion 72 or is part of a drive pinion 72 may have a gear portion 74 that includes a plurality of teeth that mesh or mate with corresponding teeth on a ring gear of the differential assembly 26. The gear portion 74 may be disposed at or near an end of the shaft 70. The gear portion 74 may be integrally formed with the shaft 70 or may be provided as a separate component that may be fixedly disposed on the shaft 70.

The differential assembly 26, which may also be called an axle differential, is configured to transmit torque between the transmission 24 and an axle shaft 28. The differential assembly 26 permits the axle shafts 28 and their associated wheel assemblies to rotate at different velocities, such as when cornering or navigating a turn, in a manner known by those skilled in the art. For example, the differential assembly 26 may have a ring gear 80 that may be fixedly mounted to a differential case. The ring gear 80 and the differential case are rotatable about a differential axis 90. The differential case may receive differential gears that may be operatively connected to the axle shafts 28.

An axle shaft 28 is configured to transmit torque between the differential assembly 26 and a corresponding wheel hub. In FIG. 1, only one axle shaft 28 is visible from the perspective shown. The axle shafts 28 are rotatable about the differential axis 90.

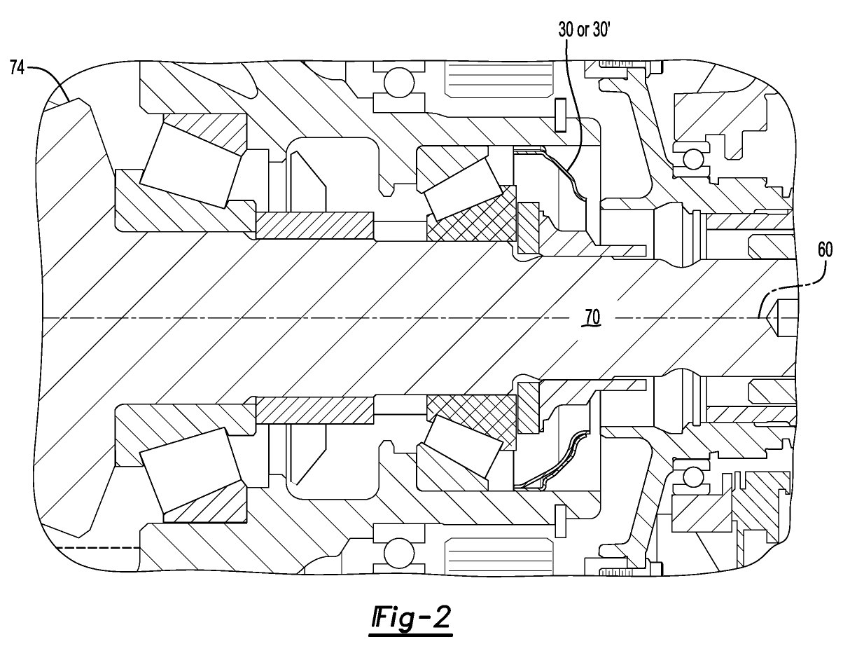

Referring to FIG. 2, a magnified view of a portion of the axle assembly 10 is shown along with an example of a fluid flow diverter 30 or 30’. The fluid flow diverter 30, 30’ encircles and is spaced apart from a rotatable shaft, such as shaft 70. In addition, the fluid flow diverter 30, 30' does not rotate about the axis 60. For instance, the fluid flow diverter 30, 30’ may be fixed to or fixedly positioned with respect to the housing assembly 20 of the axle assembly 10 such that the shaft 70 is rotatable about the axis 60 with respect to the fluid flow diverter 30, 30’. In some configurations, the fluid flow diverter 30, 30’ may be axially positioned between bearings, such as roller bearing assemblies, that rotatably support the shaft 70. In some configurations, the fluid flow diverter 30, 30’ encircles a bearing or a portion of a bearing that rotatably supports the shaft 70.

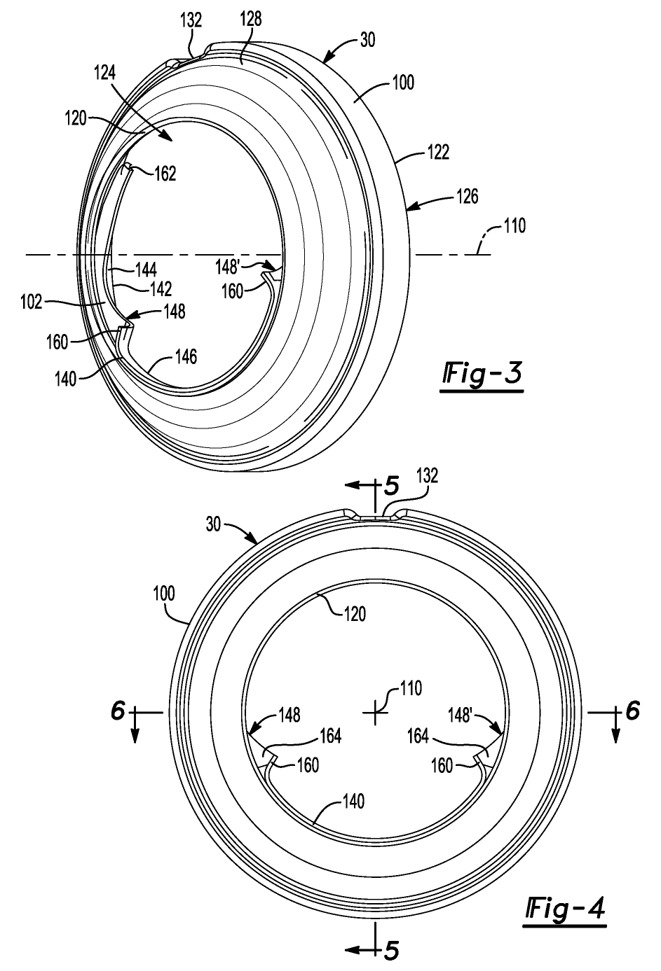

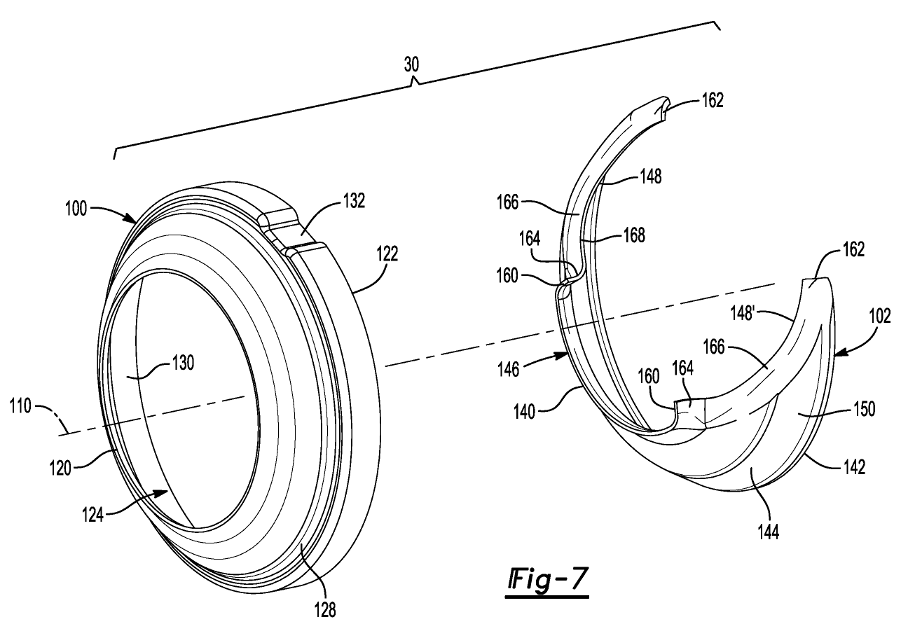

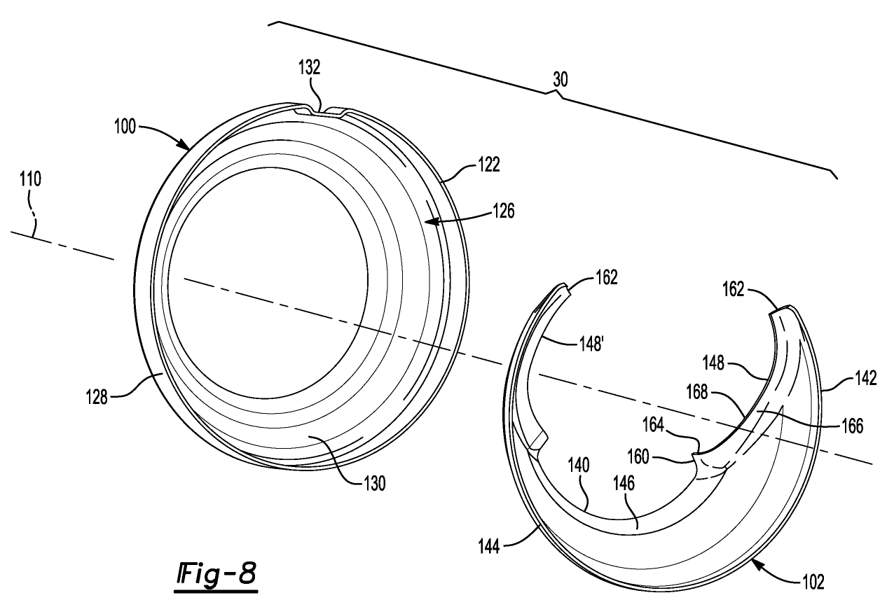

Referring to FIGS. 3-9, a first example of a fluid flow diverter 30 is shown in more detail. In this configuration, the fluid flow diverter 30 has a multipiece design that comprises a ring 100 and an insert 102. The ring 100 and insert 102 are assembled in FIGS. 3-6 and shown in exploded views in FIGS. 7 and 8. The ring 100 and the insert 102 may be made of any suitable material or materials, such as metal, a polymeric material, or combinations thereof. The ring 100 and the insert 102 may be made in any suitable manner, such as by stamping, molding, or with an additive manufacturing process (e.g., 3D printing).

The ring 100 encircles an axis 110 of the fluid flow diverter 30. The ring 100 may encircle the axis 60 and the shaft 70 when installed or provided with an axle assembly 10. In some configurations, the ring 100 comprises a first end 120, a second end 122, a first opening 124, a second opening 126, an exterior side 128, and an interior side 130, which is best shown in FIGS. 5, 7, and 8. The ring 100 may optionally include an indentation 132.

Referring primarily to FIGS. 3-8, the first end 120 encircles the first opening 124. In some configurations, the first end 120 may be disposed substantially perpendicular to the axis 110. The term “substantially perpendicular” is used herein to designate features or axes that are the same as or very close to perpendicular and includes features that are within ±3° of being perpendicular each other.

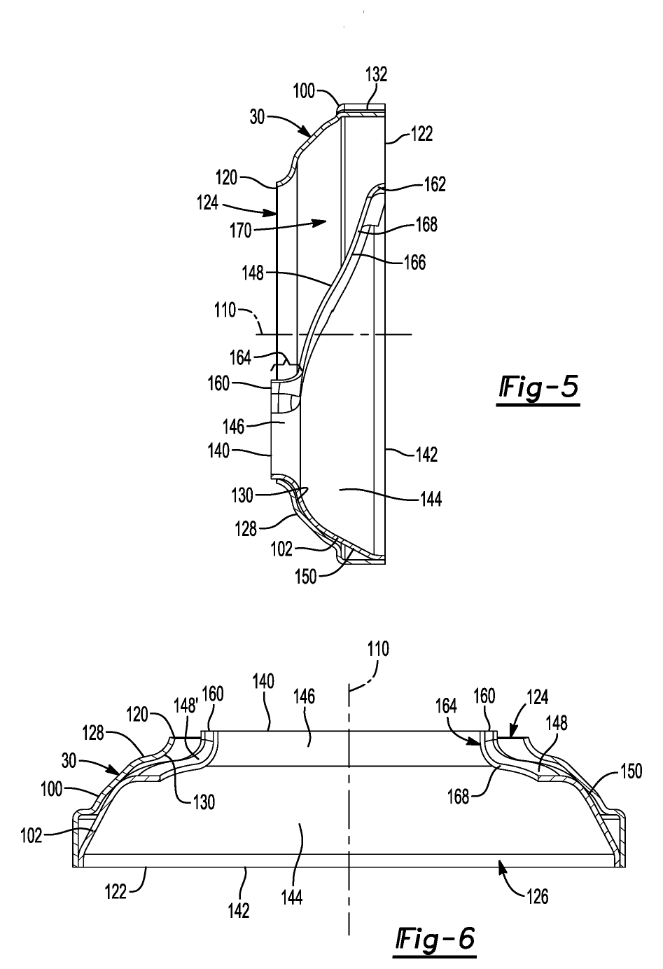

The second end 122 is disposed opposite the first end 120. The second end 122 encircles the second opening 126. In some configurations, the second end 122 may be disposed substantially perpendicular to the axis 110. As is best shown in FIGS. 5 and 6, the second end 122 may be disposed farther from the axis 110 than the first end 120 is disposed from the axis 110.

Referring primarily to FIGS. 5-7, the first opening 124 is disposed adjacent to the first end 120 of the ring 100. For instance, the first opening 124 may be encircled by the first end 120. The first opening 124 has a smaller diameter than the second opening 126. In some configurations, the first opening 124 is circular with respect to the axis 110.

Referring primarily to FIGS. 5, 6 and 8, the second opening 126 is disposed adjacent to the second end 122 of the ring 100. For instance, the second opening 126 may be encircled by the second end 122. The second opening 126 may be coaxially disposed with the first opening 124. In some configurations, the second opening 126 is circular with respect to the axis 110. In some configurations, the second opening 126 is circular where the indentation 132 is not present.

Referring primarily to FIGS. 5-7, the exterior side 128 faces away from the axis 110. The insert 102 may not contact the exterior side 128.

The interior side 130 is disposed opposite the exterior side 128. As such, the interior side 130 faces toward the axis 110. The interior side 130 may engage or contact the insert 102.

Referring primarily to FIG. 4, the indentation 132 may protrude toward the axis 110. The indentation 132 may be disposed at the top of the fluid flow diverter 30. As such, the indentation 132 may provide a visual reference that helps orient ring 100 with respect to the insert 102 during assembly of the fluid flow diverter 30, during installation of the fluid flow diverter 30 on the axle assembly 10, or both. In some configurations, the indentation 132 is spaced apart from and does not contact the insert 102.

Referring primarily to FIGS. 3 and 5-8, the insert 102 is encircled by the ring 100. Thus, the insert 102 or a portion thereof is disposed inside the ring 100. In this configuration, the insert 102 and the ring 100 are separate parts that are assembled to form the fluid flow diverter 30.

Referring primarily to FIG. 5, the insert 102 extends from the ring 100. For instance, the insert 102 may contact or engage the interior side 130 of the ring 100. In addition, the insert 102 is fixedly positioned with respect to the ring 100. The insert 102 may be fixedly positioned with respect to the ring 100 in any suitable manner, such as with an interference fit, weld, adhesive, by folding or rolling of the ring 100, or by employing a fastener, such as a rivet, threaded fastener, clip, pin, or the like.

Referring primarily to FIGS. 3, 5, 7, and 8, in some configurations the insert 102 comprises a first insert axial end 140, a second insert axial end 142, an insert body 144, an insert lip 146, and at least one vane 148, 148’.

Referring primarily to FIGS. 3-5, the first insert axial end 140 is disposed proximate the first opening 124 of the ring 100. For instance, the first insert axial end 140 or a portion thereof may be part of the insert lip 146. In some configurations, the first insert axial end 140 may be disposed substantially perpendicular to the axis 110. As is best shown in FIGS. 4 and 5, the first insert axial end 140 may be disposed below the axis 110.

Referring primarily to FIGS. 5 and 6, the second insert axial end 142 is disposed opposite the first insert axial end 140. The second insert axial end 142 may be disposed proximate the second opening 126 of the ring 100. The second insert axial end 142 or a portion thereof may be part of the insert body 144. In some configurations, the second insert axial end 142 may be disposed substantially perpendicular to the axis 110. As is best shown in FIG. 5, the second insert axial end 142 may be disposed above and below the axis 110 or extend above and below the axis 110.

The insert body 144 is configured to fit inside the ring 100. As is best shown in FIGS. 7-9, the insert body 144 extends partially around the axis 110 but does not encircle the axis 110. In some configurations, a majority of the insert body 144 may be disposed below the axis 110 as is best shown in FIGS. 5 and 9. The insert body 144 may extend in an axial direction (e.g., a direction that extends along or parallel to the axis 110) from the insert lip 146 to second insert axial end 142 of the insert 102. In some configurations, the insert body 144 may have a tapered or funnel-like configuration that extends farther away from the axis 110 as the insert body extends away from the insert lip 146 as is best shown in FIG. 6. For instance, the insert body 144 may be disposed closer to the axis 110 adjacent the insert lip 146 than at the second insert axial end 142. As is best shown in FIG. 7-9, the insert body 144 may be curved around the axis 110 when viewed along the axis 110. The insert body 144 includes an outer side 150.

The outer side 150 faces away from the axis 110. In some configurations and as is best shown in FIG. 5, the outer side 150 may engage or contact the interior side 130 of the ring 100 to help set the axial position of the insert 102 with respect to the ring 100. In some configurations, the outer side 150 of the insert 102 may engage or contact the interior side 130 at one or more locations once inserted into the second opening 126 of the ring 100.

Referring primarily to FIGS. 3 and 5, the insert lip 146 extends from the insert body 144 to the first insert axial end 140. In some configurations, the insert lip 146 may protrude into or protrude through the first opening 124. For instance, the insert lip 146 may protrude out of the first opening 124 and past the first end 120 of the ring 100. The insert lip 146 may be supported by the ring 100 at or near the first end 120. In some configurations, the insert lip 146 may extend along a curve or arc, such as when viewed along the axis 110 as is best shown in FIG. 4. In some configurations, the insert lip 146 or a portion thereof may be radially disposed with respect to the axis 110 and may have a curvature that follows the curvature of the first opening 124.

At least one vane is provided with the insert 102. In the configuration shown, two vanes are illustrated. For clarity, these vanes are designated with reference numbers 148 and 148’ and may be referred to as a (first) vane 148 and a second vane 148’ for convenience in reference. A vane 148, 148’ twists (e.g., bends, curves, spirals, etc.) partially around the axis 110 as it extends in an axial direction. In some configurations, the first vane 148 and the second vane 148’ may have mirror symmetry with respect to each other and with respect to a vertical plane along the axis 110 that bisects the fluid flow diverter 30, such as to the left and right of a vertical plane extending through the axis 110 from the perspective shown in FIG. 9.

As is best shown in FIGS. 7-9, the first vane 148 and the second vane 148’ may be disposed at opposite ends (e.g., opposite distal ends or opposite free ends) of the insert 102. As such, the first vane 148 is spaced apart from the second vane 148’ and a gap is provided between the first vane 148 and the second vane 148’. As is best shown in FIGS. 5 and 7, the first vane 148 and the second vane 148’ extend in an axial direction from the first insert axial end 140 to the second insert axial end 142 of the insert 102. As is best shown in FIGS. 8 and 9, the first vane 148 and the second vane 148’ extend generally upward and protrude toward the axis 110 from the insert body 144 and the insert lip 146. As is best shown in FIGS. 3 and 4, the first vane 148 and the second vane 148’ protrude away from the ring 100 and toward the axis 110.

Referring primarily to FIG. 5, a vane 148, 148’ comprises a first vane end 160 and a second vane end 162. In some configurations, a vane 148, 148’ comprises a first segment 164 and a second segment 166.

The first vane end 160 is an end of a vane 148, 148’ that is disposed proximate the first insert axial end 140 of the insert 102. In some configurations, the first vane end 160 may extend from or be contiguous with the first insert axial end 140. The first vane end 160 is disposed below the axis 110. In some configurations, the first vane end 160 is disposed closer to the axis 110, such as along a radial line or radially disposed closer to the axis 110, than the second vane end 162 is disposed to the axis 110 as is best shown in FIG. 9.

Referring primarily to FIG. 5, the second vane end 162 is disposed at an opposite end of the vane 148, 148’ from the first vane end 160. As such, the second vane end 162 may be disposed proximate the second insert axial end 142. The second vane end 162 may extend from or be contiguous with the second insert axial end 142. The second vane end 162 is disposed above the axis 110. In some configurations, at least a portion of the vane 148, 148’ may be curved or may extend along at least one arc between the first vane end 160 and the second vane end 162.

The first segment 164 extends from the first vane end 160 toward the second vane end 162. The first segment 164 may be disposed below the axis 110 and may be generally extend in the same direction as the axis 110 to help direct fluid. In some configurations, the first segment 164 is disposed in or extends into the first opening 124 of the ring 100. As is best shown in FIG. 4, the first segment 164 may protrude generally toward the axis 110 such that the first segment 164 is visible in the first opening 124 when viewed along the axis 110. Such a configuration may help the vane 148, 148’ capture or direct fluid. For instance, such a configuration may help the vane 148, 148’ direct through the first opening 124 when fluid flows through the fluid flow diverter 30 toward the first opening 124.

Referring primarily to FIGS. 5 and 8. the second segment 166 extends from the first segment 164 to the second vane end 162. The second segment 166 may have an inner side 168. The inner side 168 may face toward the axis 110 and may be a distal end or free end of the insert 102. As is best shown in FIG. 9, the inner side 168 may be disposed farther from the axis 110 as the distance from the first segment 164 increases. The second segment 166 may be disposed at a steeper angle or larger angle with respect to the axis 110 than the first segment 164.

Referring primarily to FIG. 5, the ring 100 and the vane 148, 148’ may cooperate to define a channel 170. The channel 170 extends in an axial direction (e.g., a direction that extends along or parallel to the axis 110) from the first end 120 of the ring 100 to the second end 122 of the ring 100. The channel 170 may also generally extend farther from the axis 110 as the channel 170 extends from the first end 120 toward the second end 122.

The channel 170 helps direct fluid through the fluid flow diverter 30. For instance, a vane 148, 148’ may help deflect or direct fluid inside the ring 100 in an axial direction, which may help increase fluid flow through the ring 100. As an example, fluid may generally be flung away from the axis 110 when the shaft 70 rotates. Some fluid may be generally captured in the ring 100 and may rotate about the axis 110 rather than flow through the ring 100. The vane 148, 148’ may help redirect or route fluid in an axial direction. For instance, fluid may contact or be redirected by the vane 148, 148’ toward an opening (e.g., first opening 124), thereby increasing the fluid flow rate as compared to a configuration that lacks a vane.

The fluid flow diverter 30 may be bidirectional and facilitate fluid flow from the second opening 126 to the first opening 124 when the shaft 70 rotates in a clockwise direction or a counterclockwise direction about its axis of rotation (e.g., axis 110). In some configurations, one vane may primarily direct fluid from the second opening 126 toward the first opening 124 when the shaft 70 rotates in a first rotational direction about axis 110 while the other vane may primarily direct fluid from the second opening 126 toward the first opening 124 when the shaft 70 rotates in a second rotational direction or opposite rotational direction about axis 110. As an example, a vane 148 may help alter rotational flow of a fluid around the axis 110 so that more fluid flows in an axial direction and the ring 100 may help funnel fluid from the larger diameter second opening 126 toward the smaller diameter first opening 124 when the shaft 70 rotates in a first rotational direction about axis 110. In some configurations, another vane 148’ may help alter rotational flow of a fluid around the axis 110 so that fluid flows in the same axial direction (i.e., from the larger diameter second opening 126 toward the smaller diameter first opening 124) when the shaft 70 rotates in a second rotational direction about axis 110 that is opposite the first rotational direction.

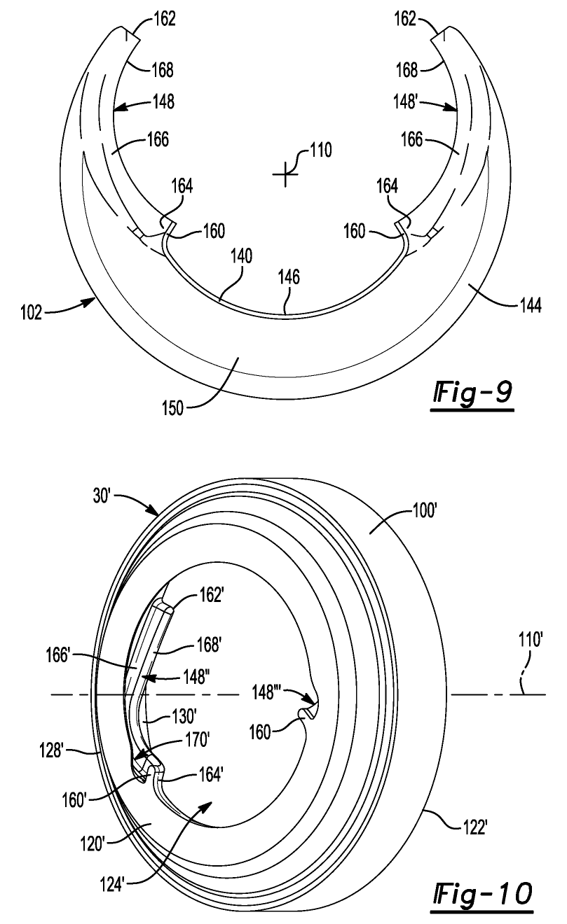

Referring to FIGS. 10-14, another example of a fluid flow diverter 30’ is shown. In this configuration, the fluid flow diverter 30’ has a unitary one-piece design. The fluid flow diverter 30’ comprises a ring 100’. The ring 100’ encircles an axis 110’ of the fluid flow diverter 30’. The ring 100’ may encircle the axis 60 and the shaft 70 when installed or provided with an axle assembly 10. The ring 100’ comprises a first end 120’, a second end 122’, a first opening 124’, a second opening 126’, an exterior side 128’, an interior side 130’, and at least one vane 148’’, 148’’’.

The first end 120’ encircles the first opening 124’. In some configurations, the first end 120’ may be disposed substantially perpendicular to the axis 110’.

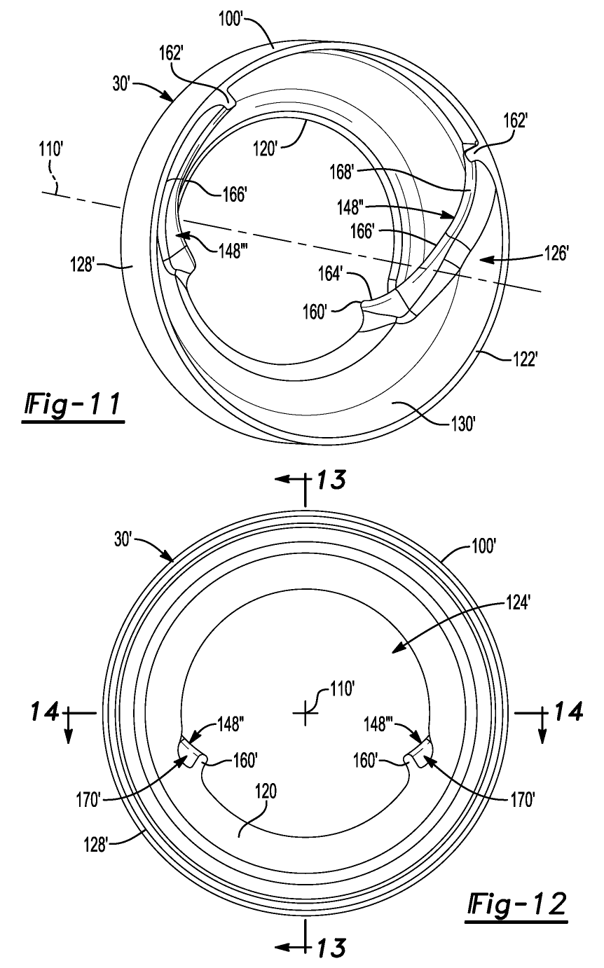

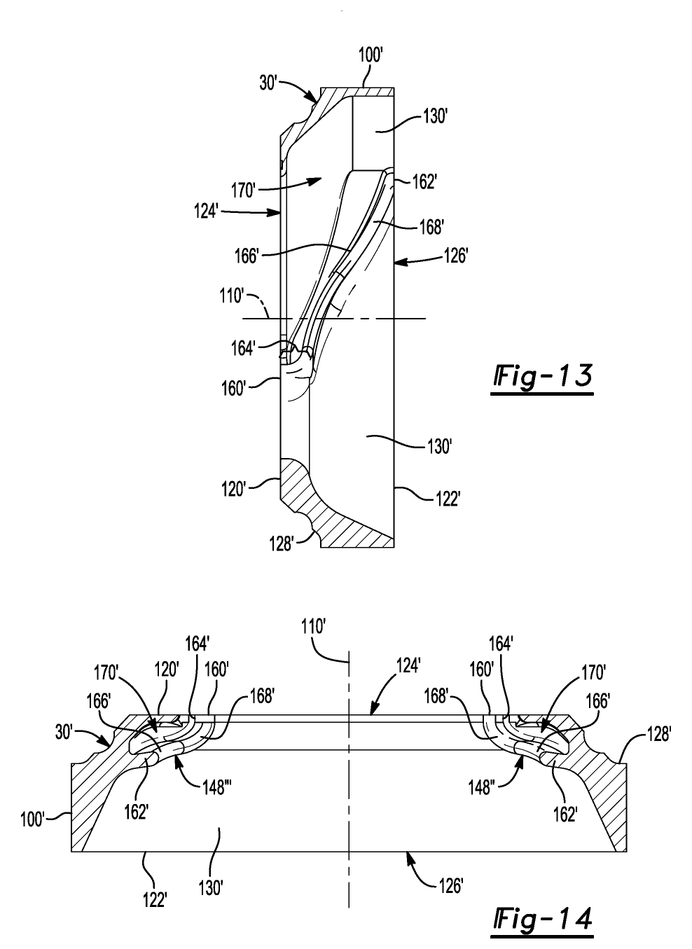

Referring primarily to FIG. 11, the second end 122’ is disposed opposite the first end 120’. The second end 122’ encircles the second opening 126’. In some configurations, the second end 122’ may be disposed substantially perpendicular to the axis 110’. As is best shown in FIGS. 13 and 14, the second end 122’ may be disposed farther from the axis 110’ than the first end 120’ is disposed from the axis 110’.

The first opening 124’ is disposed adjacent to the first end 120’. For instance, the first opening 124’ may be encircled by the first end 120’. The first opening 124’ has a smaller diameter than the second opening 126’. In some configurations, the first opening 124’ is circular and centered about the axis 110’.

The second opening 126’ is disposed adjacent to the second end 122’. For instance, the second opening 126’ may be encircled by the second end 122’. The second opening 126’ may be coaxially disposed with the first opening 124’. In some configurations, the second opening 126’ is circular with respect to the axis 110’. In some configurations, the second opening 126’ is circular and centered about the axis 110’.

The exterior side 128’ faces away from the axis 110’.

The interior side 130’ is disposed opposite the exterior side 128’. As such, the interior side 130’ faces toward the axis 110’.

At least one vane protrudes away from the ring 100’ and toward the axis 110’. For instance, a vane may protrude or extend from the interior side 130’ toward the axis 110’. In the configuration shown, two vanes are illustrated. For clarity, these vanes are designated with reference numbers 148’’ and 148’’’ and may be referred to as a (first) vane 148’’ and a second vane 148’’’ for convenience in reference. Vanes 148’’ and 148’’’ may be analogous to or have a configuration similar to vanes 148 and 148’ discussed above. The vanes 148’’, 148’’’ are spaced apart from each other. A vane 148’’ 148’’’ twists (e.g., bends, curves, spirals, etc.) partially around the axis 110 as it extends in an axial direction.

As is best shown in FIG. 13, the first vane 148’’ and the second vane 148’’’ extend in an axial direction from the first end 120’ to the second end 122’. As is best shown in FIGS. 11 and 13, the first vane 148’’ and the second vane 148’’’ are disposed closer to the axis 110’ at the first end 120’ than at the second end 122’. As is best shown in FIG. 11, the first vane 148’’ and the second vane 148’’’ extend generally upward from the first end 120’ to the second end 122’.

Referring primarily to FIG. 13, a vane 148’’, 148’’’ comprises a first vane end 160’ and a second vane end 162’. In some configurations, a vane 148’’, 148’’’ comprises a first segment 164’ and a second segment 166’.

The first vane end 160’ is an end of a vane 148, 148’ that is disposed proximate the first end 120’. The first vane end 160’ may extend from or be contiguous with the first end 120’. The first vane end 160’ is disposed below the axis 110’. In some configurations, the first vane end 160’ is radially disposed closer to the axis 110’ than the second vane end 162’ is disposed to the axis 110’ as is best shown in FIG. 11.

The second vane end 162’ is disposed at an opposite end of the vane 148’’, 148’’’ from the first vane end 160’. As such, the second vane end 162’ may be disposed proximate the second end 122’. The second vane end 162’ may extend from or be contiguous with the second end 122’. The second vane end 162’ is disposed above the axis 110’. In some configurations, at least a portion of the vane 148’’, 148’’’ may be curved or may extend along at least one arc between the first vane end 160’ and the second vane end 162’.

Referring primarily to FIG. 13, the first segment 164’ may be similar to the first segment 164 previously discussed. For example, the first segment 164’ may extend from the first vane end 160’ toward the second vane end 162’ and second end 122’ and may be disposed below the axis 110’. As is best shown in FIG. 12, the first segment 164’ may protrude generally toward the axis 110’ such that the first segment 164’ is visible in the first opening 124’ when viewed along the axis 110’. Such a configuration may help the vane 148’’, 148’’’ direct fluid through the first opening 124’ when fluid flows through the fluid flow diverter 30’ toward the first opening 124’. Such a configuration may also help the vane 148’’, 148’’’ capture fluid that enters the first opening 124’ when fluid flows through the fluid flow diverter 30’ toward the second opening 126’.

Referring to FIG. 13. the second segment 166’ extends from the first segment 164’ to the second vane end 162’. The second segment may have an inner edge or inner side 168’. The inner side 168’ may face toward the axis 110’ and may be a distal end or free end of the vane. The inner side 168’ may be disposed farther from the axis 110’ as the distance from the first segment 164’ increases.

Referring primarily to FIG. 13, the interior side 130’ and the vane 148’’, 148’’’ may cooperate to define a channel 170’. The channel 170’ extends in an axial direction (e.g., a direction that extends along or parallel to the axis 110’) from the first end 120’ to the second end 122’ of the ring 100. The channel 170’ may also generally extend farther from the axis 110’ as the channel 170’ extends from the first end 120’ toward the second end 122’. The channel 170’ helps direct fluid through the fluid flow diverter 30’ as previously discussed with respect to fluid flow diverter 30'.

A fluid flow diverter of the present invention may increase fluid flow or the fluid flow rate as compared to other designs, such as a symmetrical funnel. As a result, a fluid flow diverter may help improve or increase fluid flow without the addition of a separate powered pumping device, which would increase cost and complexity. Increased fluid flow may help provide more lubricant to rotating components to help improve component life. In addition, increased fluid flow may improve or increase heat transfer from components to the fluid, which may help reduce operating temperatures.

The present invention may provide a fluid flow diverter that improves fluid flow therethrough when a shaft rotates in either direction about its axis of rotation. Thus, the fluid flow diverter may help improve fluid flow regardless of the direction of rotation of a shaft that is disposed in the fluid flow diverter and the direction that fluid rotates inside the fluid flow diverter.

The present invention may allow a fluid flow diverter to be provided with a compact design, which may make it easier to package the fluid flow diverter when limited space is available.

The present invention may allow a fluid flow diverter to be inexpensively manufactured with few parts, which may reduce manufacturing costs and complexity.

Clause 1. A fluid flow diverter comprising: a ring that encircles an axis; and a vane that protrudes away from the ring and toward the axis, wherein the vane comprises a first vane end and a second vane end opposite the first vane end, wherein the first vane end is below the axis and the second vane end is above the axis.

Clause 2. The fluid flow diverter of clause 1 wherein the first vane end is disposed closer to the axis than the second vane end.

Clause 3. The fluid flow diverter of any preceding clause wherein the first vane end is radially disposed closer to the axis than the second vane end is disposed to the axis.

Clause 4. The fluid flow diverter of any preceding clause wherein at least a portion of the vane extends along an arc between the first vane end and the second vane end.

Clause 5. The fluid flow diverter of any preceding clause further comprising an insert that is encircled by the ring, wherein the insert and the ring are separate parts and the vane is provided with the insert.

Clause 6. The fluid flow diverter of clause 5 wherein the insert extends from the ring and is fixedly positioned with respect to the ring.

Clause 7. The fluid flow diverter of clause 5 or clause 6 further comprising a second vane that protrudes away from the ring and toward the axis, wherein the vane and the second vane are disposed at opposite ends of the insert.

Clause 8. The fluid flow diverter of any of clauses 5 to 7 wherein the vane comprises: a first segment extending from the first vane end, wherein the first segment is disposed below the axis; and a second segment extending from the first segment to the second vane end.

Clause 9. The fluid flow diverter of clause 8 wherein the second segment has an inner side that faces toward the axis, wherein the inner side is disposed farther from the axis as a distance from the first segment increases.

Clause 10. The fluid flow diverter of clause 8 or clause 9 wherein the ring comprises: a first end, the first end encircling a first opening; and a second end opposite the first end, the second end encircling a second opening, wherein the first segment is disposed in the first opening of the ring.

Clause 11. The fluid flow diverter of clause 10 wherein the first opening has a smaller diameter than the second opening.

Clause 12. The fluid flow diverter of clause 10 or clause 11 wherein the vane and the ring cooperate to define a channel that extends in an axial direction from the first end to the second end of the ring.

Clause 13. The fluid flow diverter of any of clauses 1 to 4 wherein the ring comprises the vane.

Clause 14. The fluid flow diverter of clause 13 wherein the ring comprises: a first end, the first end encircling a first opening; a second end opposite the first end, the second end encircling a second opening; and an interior side that faces toward the axis; wherein the vane extends from the interior side toward the axis; and wherein the vane extends from the first end to the second end and is disposed closer to the axis at the first end than at the second end.

Clause 15. The fluid flow diverter of clause 14 wherein the first opening has a smaller diameter than the second opening.

Clause 16. The fluid flow diverter of clause 14 or clause 15 wherein the vane comprises: a first segment extending from the first vane end toward the second end of the ring, wherein the first segment is disposed below the axis; and a second segment extending from the first segment to the second vane end.

Clause 17. The fluid flow diverter of clause 16 wherein the second segment is disposed farther from the axis as a distance from the first segment increases.

Clause 18. The fluid flow diverter of any of clauses 14 to 17 wherein the ring and the vane cooperate to define a channel that extends in an axial direction from the first end to the second end of the ring.

Clause 19. An axle assembly comprising: a shaft extending along an axis; and a fluid flow diverter that is spaced apart from the shaft, wherein the fluid flow diverter comprises: a ring that encircles the shaft; and a vane that protrudes away from the ring and toward the axis, wherein the vane comprises a first vane end and a second vane end opposite the first vane end, wherein the first vane end is below the axis and the second vane end is above the axis.

Clause 20. The axle assembly of clause 19 wherein the shaft is a drive pinion that is rotatable about the axis.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fluid flow diverter comprising:
a ring that encircles an axis; and
a vane that protrudes away from the ring and toward the axis, wherein the vane comprises a first vane end and a second vane end opposite the first vane end, wherein the first vane end is below the axis and the second vane end is above the axis.

2. The fluid flow diverter of claim 1 wherein the first vane end is disposed closer to the axis than the second vane end.

3. The fluid flow diverter of claim 1 wherein the first vane end is radially disposed closer to the axis than the second vane end is disposed to the axis.

4. The fluid flow diverter of claim 1 wherein at least a portion of the vane extends along an arc between the first vane end and the second vane end.

5. The fluid flow diverter of claim 1 further comprising an insert that is encircled by the ring, wherein the insert and the ring are separate parts and the vane is provided with the insert.

6. The fluid flow diverter of claim 5 wherein the insert extends from the ring and is fixedly positioned with respect to the ring.

7. The fluid flow diverter of claim 5 further comprising a second vane that protrudes away from the ring and toward the axis, wherein the vane and the second vane are disposed at opposite ends of the insert.

8. The fluid flow diverter of claim 5 wherein the vane comprises:
a first segment extending from the first vane end, wherein the first segment is disposed below the axis; and
a second segment extending from the first segment to the second vane end.

9. The fluid flow diverter of claim 8 wherein the second segment has an inner side that faces toward the axis, wherein the inner side is disposed farther from the axis as a distance from the first segment increases.

10. The fluid flow diverter of claim 8 wherein the ring comprises:
a first end, the first end encircling a first opening; and
a second end opposite the first end, the second end encircling a second opening, wherein the first segment is disposed in the first opening of the ring.

11. The fluid flow diverter of claim 10 wherein the first opening has a smaller diameter than the second opening.

12. The fluid flow diverter of claim 10 wherein the vane and the ring cooperate to define a channel that extends in an axial direction from the first end to the second end of the ring.

13. The fluid flow diverter of claim 1 wherein the ring comprises the vane.

14. The fluid flow diverter of claim 13 wherein the ring comprises:
a first end, the first end encircling a first opening;
a second end opposite the first end, the second end encircling a second opening; and
an interior side that faces toward the axis;
wherein the vane extends from the interior side toward the axis; and
wherein the vane extends from the first end to the second end and is disposed closer to the axis at the first end than at the second end.

15. The fluid flow diverter of claim 14 wherein the first opening has a smaller diameter than the second opening.

16. The fluid flow diverter of claim 14 wherein the vane comprises:
a first segment extending from the first vane end toward the second end of the ring, wherein the first segment is disposed below the axis; and
a second segment extending from the first segment to the second vane end.

17. The fluid flow diverter of claim 16 wherein the second segment is disposed farther from the axis as a distance from the first segment increases.

18. The fluid flow diverter of claim 14 wherein the ring and the vane cooperate to define a channel that extends in an axial direction from the first end to the second end of the ring.

19. An axle assembly comprising:
a shaft extending along an axis; and
a fluid flow diverter that is spaced apart from the shaft, wherein the fluid flow diverter comprises:
a ring that encircles the shaft; and
a vane that protrudes away from the ring and toward the axis, wherein the vane comprises a first vane end and a second vane end opposite the first vane end, wherein the first vane end is below the axis and the second vane end is above the axis.

20. The axle assembly of claim 19 wherein the shaft is a drive pinion that is rotatable about the axis.
